(19) United States
(12) Patent Application Publication
(10) Pub. No.: US 2023/0171481 A1
(43) Pub. Date: Jun. 1, 2023

(54) IMAGING SYSTEM, IMAGING METHOD, AND COMPUTER PROGRAM

(71) Applicant: NEC Corporation, Minato-ku, Tokyo (JP)

(72) Inventors: Yuka OGINO, Tokyo (JP); Keiichi CHONO, Tokyo (JP)

(73) Assignee: NEC Corporation, Minato-ku, Tokyo (JP)

(21) Appl. No.: 17/920,908

(22) PCT Filed: Apr. 28, 2020
(86) PCT No.: PCT/JP2020/018151

§ 371 Date: Oct. 24, 2022

(51) Int. Cl. H04N 23/611; H04N 23/82; G06T 7/70; H04N 23/698

(52) U.S. Cl. CPC H04N 23/611; G06T 7/70; H04N 23/82; H04N 23/698; G06T 2207/20212; G06V 40/18

(57) ABSTRACT

An imaging system includes: a first control unit that controls an imaging unit to capture a first image of a subject at a first pixel density; a detection unit that detects an eye position of the subject from the first image; a setting unit that sets a peripheral area around eyes of the subject on the basis of the eye position; and a second control unit that controls the imaging unit to capture a second image of the peripheral area at a second pixel density that is higher than the first pixel density. According to such an imaging system, it is possible to properly capture an image of the periphery of the eyes of the subject.

### TECHNICAL FIELD

This disclosure relates to an imaging system, an imaging method, and a computer program that image a subject.

### BACKGROUND ART

A known system of this type captures an image that is used for iris authentication. For example, Patent Literature 1 discloses a technique/technology of detecting a face and eyes of a target person to identify a region of interest of an iris. Patent Literature 2 discloses a technique/technology of generating a low-resolution image from a high-resolution image to perform pupil detection from the low-resolution image.

As another related art, Patent Literature 3 discloses a technique/technology of synthesizing a plurality of images to generate a composite image of a wide angle of view.

### CITATION LIST

### Patent Literature

Patent Literature 1: JP2007-504562A
Patent Literature 2: JP2017-134542A
Patent Literature 3: JP2012-191486A

### SUMMARY

### Technical Problem

An iris camera for capturing an image for iris authentication is generally set to have a large number of pixels and a narrow angle of view. For this reason, it is hard to capture a wide-angle image that allows the iris camera to detect an eye position of a subject due to the restrictions of communication velocity and a range of angle of view. Each cited document described above does not mention such problems, and there is room for improvement.

In view of the above problems, it is an example object of this disclosure to provide an imaging system, an imaging method, and a computer program that are configured to properly capture an image of the periphery of the eyes of the subject.

### Solution to Problem

An imaging system according to an example aspect of this disclosure includes: a first control unit that controls an imaging unit to capture a first image of a subject at a first pixel density; a detection unit that detects an eye position of the subject from the first image; a setting unit that sets a peripheral area around eyes of the subject on the basis of the eye position; and a second control unit that controls the imaging unit to capture a second image of the peripheral area at a second pixel density that is higher than the first pixel density.

An imaging method according to an example aspect of this disclosure includes: controlling an imaging unit to capture a first image of a subject at a first pixel density; detecting an eye position of the subject from the first image; setting a peripheral area around eyes of the subject on the basis of the eye position; and controlling the imaging unit to capture a second image of the peripheral area at a second pixel density that is higher than the first pixel density.

A computer program according to an example aspect of this disclosure operates a computer: to control an imaging unit to capture a first image of a subject at a first pixel density; to detect an eye position of the subject from the first image; to set a peripheral area around eyes of the subject on the basis of the eye position; and to control the imaging unit to capture a second image of the peripheral area at a second pixel density that is higher than the first pixel density.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 FIG. 1 is a block diagram illustrating a hardware configuration of an imaging system according to a first example embodiment.

FIG. 2 is a block diagram illustrating a functional configuration of the imaging system according to the first example embodiment.

FIG. 3 is a flowchart illustrating a flow of operation of the imaging system according to the first example embodiment.

FIG. 4 is a conceptual diagram illustrating the imaging timing and imaging range of a first image and a second image according to the first example embodiment.

FIG. 5 is a block diagram illustrating a functional configuration of an imaging system according to a second example embodiment.

FIG. 6 is a flowchart illustrating a flow of operation of the imaging system according to the second example embodiment.

FIG. 7 is a conceptual diagram illustrating the imaging timing and imaging range of the first image and the second image according to the second example embodiment.

FIG. 8 is a block diagram illustrating a functional configuration of an imaging system according to a third example embodiment.

FIG. 9 is a flowchart illustrating a flow of operation of the imaging system according to the third example embodiment.

FIG. 10 is a block diagram illustrating a functional configuration of an imaging system according to a fourth example embodiment.

FIG. 11 is a flowchart illustrating a flow of operation of the imaging system according to the fourth example embodiment.

FIG. 12 is a conceptual diagram illustrating the imaging timing and imaging range of the first image and the second image according to a fifth example embodiment.

FIG. 13 is a conceptual diagram illustrating an operation when pixels are thinned out and the first image of low resolution is captured.

FIG. 14 is a conceptual diagram illustrating an operation when an imaging area is limited to be small and the first image is captured.

### DESCRIPTION OF EXAMPLE EMBODIMENTS

Hereinafter, an imaging system, an imaging method, and a computer program according to example embodiments will be described with reference to the drawings.

### First Example Embodiment

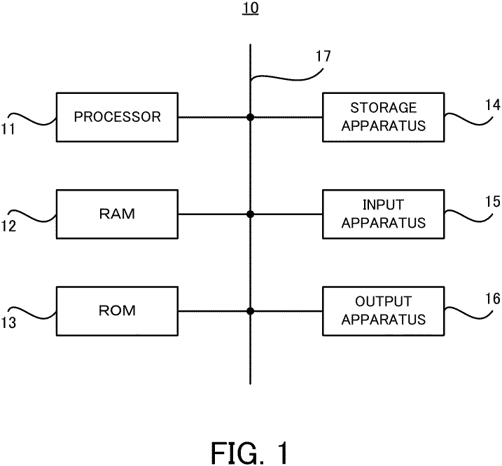

An imaging system according to a first example embodiment will be described with reference to FIG. 1 to FIG. 4.

### Hardware Configuration

First, with reference to FIG. 1, a hardware configuration of an imaging system 10 according to the first example embodiment will be described. FIG. 1 is a block diagram illustrating the hardware configuration of the imaging system according to the first example embodiment.

As illustrated in FIG. 1, the imaging system 10 according to the first example embodiment includes a processor 11, a RAM (Random Access Memory) 12, a ROM (Read Only Memory) 13, and a storage apparatus 14. The imaging system 10 may also include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored in at least one of the RAM 12, the ROM 13 and the storage apparatus 14. Alternatively, the processor 11 may read a computer program stored by a computer readable recording medium by using a not-illustrated recording medium reading apparatus. The processor 11 may obtain (i.e., read) a computer program from a not-illustrated apparatus that is located outside the imaging system 10 through a network interface. The processor 11 controls the RAM 12, the storage apparatus 14, the input apparatus 15, and the output apparatus 16 by executing the read computer program. Especially in the first example embodiment, when the processor 11 executes the read computer program, a functional block for imaging a subject is realized or implemented in the processor 11. As the processor 11, any one of a CPU (Central Processing Unit), a GPU (Graphics Processing Unit), a FPGA (field-programmable gate array), a DSP (digital signal processor), and an ASIC (application specific integrated circuit) may be used. Furthermore, a plurality of those may be used in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the imaging system 10. The storage apparatus 14 may operate as a temporary storage apparatus of the processor 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the imaging system 10. The input apparatus 15 may include, for example, at least one of a keyboard, a mouse, and a touch panel.

The output apparatus 16 is an apparatus that outputs information about the imaging system 10 to the outside. For example, the output apparatus 16 may be a display apparatus (e.g., a display) that is configured to display the information about the imaging system 10.

### Functional Configuration

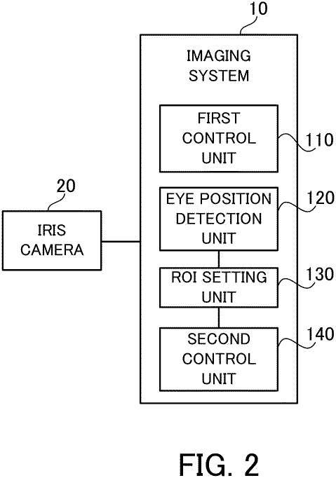

Next, with reference to FIG. 2, a functional configuration of the imaging system 10 according to the first example embodiment will be described. FIG. 2 is a block diagram illustrating the functional configuration of the imaging system according to the first example embodiment.

As illustrated in FIG. 2, the imaging system 10 according to the first example embodiment is connected to an iris camera 20. The imaging system 10 includes, as processing blocks for realizing the function, a first control unit 110, an eye position detection unit 120, a ROI setting unit 130, and a second control unit 140. The first control unit 110, the eye position detection unit 120, the ROI setting unit 130, and the second control unit 140 may be realized or implemented, for example, in the processor 11 described above (see FIG. 1).

The first control unit 110 is configured to capture a first image of the subject by controlling the iris camera 20. The first image is an image used to detect an eye position of the subject, and is captured at a first pixel density that is relatively low. The first image is captured, for example, such that the subject entirely fits in an imaging range.

The eye position detection unit 120 detects the eye position of the subject (i.e., where the eyes are) by using the first image captured by the control of the first control unit 110. Since the existing techniques/technologies can be properly adopted to a method of detecting the eye position of the subject from the image, a more specific description of the method will be omitted. Information about the eye position of the subject detected by the eye position detection unit 120 is configured to be outputted to the ROI setting unit.

The ROI setting unit 130 is configured to set a ROI (Region Of Interest) fir imaging an iris of the subject on the basis of the eye position of the subject detected by the eye position detection unit 120. The ROI is set as an area through which the eyes of the subject likely pass at a focal point of the iris camera 20. Since the existing techniques/technologies can be properly adopted to a method of setting the ROI from the eye position, a more specific description of the method will be omitted. Information about the ROI set by the ROI setting unit 130 is configured to be outputted to the second control unit 140.

The second control unit 140 is configured to capture a second image of the subject by controlling the iris camera 20. The second image is an image that is captured as an area set by the ROI setting unit 130, and is captured at a second pixel density that is higher than the first pixel density (i.e., the pixel density when the first image is captured). Consequently, the second image is an image obtained by imaging an area around the eyes of the subject at high resolution.

### Flow of Operation

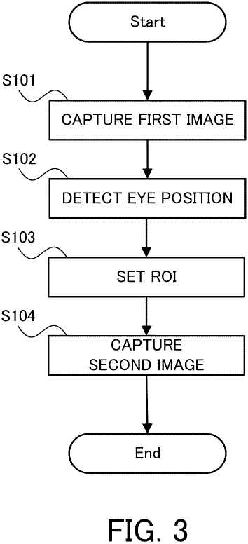

Next, with reference to FIG. 3, a flow of operation of the imaging system 10 according to the first example embodiment will be described. FIG. 3 is a flowchart illustrating the flow of the operation of the imaging system according to the first example embodiment.

As illustrated in FIG. 3, in operation of the imaging system 10 according to the first example embodiment, first, the first control unit 110 controls the iris camera 20 to capture the first image of the subject (step S101). The first image is captured at the first pixel density.

Then, the eye position detection unit 120 detects the eye position of the subject from the first image (step S102). Then, the ROI setting unit 130 sets the ROI on the basis of the detected eye position (step S103).

Then, the second control unit 140 controls the iris camera 20 to capture the second image at the set ROI (step S104). The second image is captured at the second pixel density that is higher than the first pixel density.

### Technical Effect

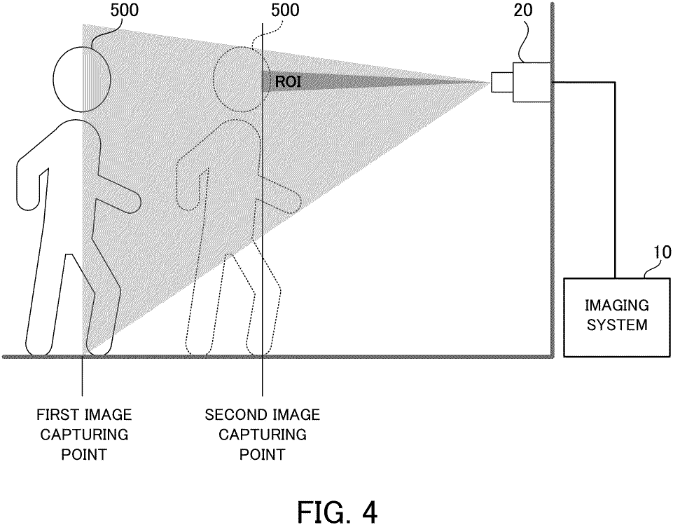

Next, with reference to FIG. 4, a technical effect obtained by the imaging system 10 according to the first example embodiment will be described. FIG. 4 is a conceptual diagram illustrating the imaging timing and imaging range of the first image and the second image according to the first example embodiment.

As illustrated in FIG. 4, in the imaging system 10 according to the first example embodiment, the first image is captured at the first pixel density, and the second image is then captured the second pixel density. Here in particular, since the first pixel density is lower than the second pixel density, it is possible to relatively reduce a data volume of the first image. Therefore, it is possible to prevent an increased data volume of the first image that is required to have a relatively wide angle of view. Consequently, it is possible to shorten a period required for the communication and processing of the first image, and it is possible to smoothly perform a process from the capture of the first image to the capture of the second image (e.g., a process of detecting the eye position, a process of setting the ROI, etc.).

A dedicated camera (i.e., a low-resolution camera) may be separately installed to capture the first image; however, in that case, a cost increase and sophistication of the system may be problematic. According to the imaging system of the first example embodiment, however, the iris camera 20 is configured to capture both the first image (i.e., an image for detecting the eye position to set the ROI) and the second image (i.e., a high-definition iris image). Therefore, it is possible to properly capture the iris image of the subject without incurring the above-described cost increase or sophistication of the system. Furthermore, if there are multiple types of cameras, it is necessary to make the user face each camera, so that the user may be aware of the presence of the cameras, which may be complicated for the user. According to the imaging system 10 in the first example embodiment, the eye position can be specified by a low-quality image and an iris area can be specified, only by using the iris camera having a narrow angle of view. It also eliminates a need for the user to be aware of the cameras.

### Modified Examples

Hereinafter, modified examples of the first example embodiment will be described. The following modified examples may be also combined.

### First Modified Example

The first control unit 110 may capture the first image, for example, at a time when the subject arrives at a predetermined trigger point. The timing in which the subject arrives at the trigger point may be detected, for example, by various sensors or the like installed around the trigger point.

### Second Modified Example

The second control unit 140 may capture the second image, for example, at a time when the subject arrives at the focal point of the iris camera 20 set in advance. The second control unit 140 may predict the timing in which the subject arrives at the focal point, and may capture a plurality of second images continuously near the timing.

### Third Modified Example

The second image captured by the control of the second control unit 140 may be inputted to a not-illustrated biometric authentication unit and may be used for iris authentication of the subject. The biometric authentication unit may be provided as a part of the imaging system 10, or may be provided outside the imaging system 10 (e.g., an external server or a cloud, etc.). Since the existing techniques/technologies can be properly adopted to the authentication using the iris image (i.e., the second image), a more specific description here will be omitted.

### Second Example Embodiment

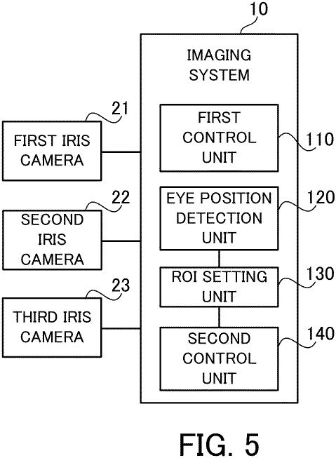

The imaging system 10 according to a second example embodiment will be described with reference to FIG. 5 to FIG. 7. The second example embodiment is partially different from the first example embodiment described above only in configuration and operation, and is substantially the same in the other parts. Therefore, the parts that differ from the first example embodiment will be described in detail below, and the other overlapping parts will not be described as appropriate.

### Hardware Configuration

A hardware configuration of the imaging system 10 according to the second example embodiment may be the same as the hardware configuration of the first example embodiment described in FIG. 1. Therefore, a description of the hardware configuration of the imaging system 10 according to the second example embodiment will be omitted.

### Functional Configuration

Next, with reference to FIG. 5, a functional configuration of the imaging system 10 according to the second example embodiment will be described. FIG. 5 is a block diagram illustrating the functional configuration of the imaging system according to the second example embodiment. In FIG. 5, the same components as those illustrated in FIG. 2 carry the same reference numerals.

As illustrated in FIG. 5, the imaging system 10 according to the second example embodiment is connected to each of a first iris camera 21, a second iris camera 22, and a third iris camera 23 (hereinafter collectively referred to as the “iris cameras 20”). That is, the imaging system 10 according to the second example embodiment is configured to control the imaging by the plurality of iris cameras 20. Furthermore, the imaging system 10 includes, as processing blocks for realizing the function, the first control unit 110, the eye position detection unit 120, the ROI setting unit 130, and the second control unit 140.

### Flow of Operation

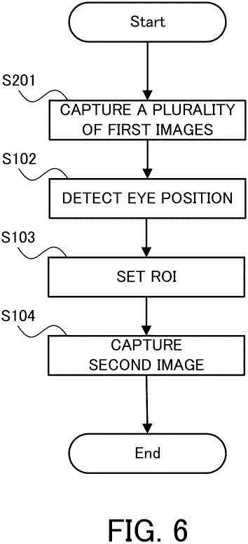

Next, with reference to FIG. 6, a flow of operation of the imaging system 10 according to the second example embodiment will be described. FIG. 6 is a flowchart illustrating the flow of the operation of the imaging system according to the second example embodiment. In FIG. 6, the same steps as those as illustrated in FIG. 3 carry the same reference numerals.

As illustrated in FIG. 6, in operation of the imaging system 10 according to the second example embodiment, first, the first control unit 110 controls each of the first iris camera 21, the second iris camera 22, and the third iris camera 23 to capture the first image of the subject (step S201). It is preferable that each of the iris cameras 20 captures the first image at the same timing, but there may be some deviation in the imaging timing.

Then, the eye position detection unit 120 detects the eye position of the subject from a plurality of first images (the step S102). Then, the ROI setting unit 130 sets the ROI on the basis of the detected eye position (the step S103).

Then, the second control unit 140 controls the iris cameras 20 to capture the second image at the set ROI (the step S104). The second image may be captured by one of the first iris camera 21, the second iris camera 22, and the third iris camera 23. That is, it is not necessary that all the iris cameras 20 separately capture the second image. The iris camera 20 that captures the second image may be determined in accordance with the ROI set in the ROI setting section 130, for example. Specifically, it is sufficient that the second image is captured by the iris camera 20 including the ROI in the imaging range.

### Technical Effect

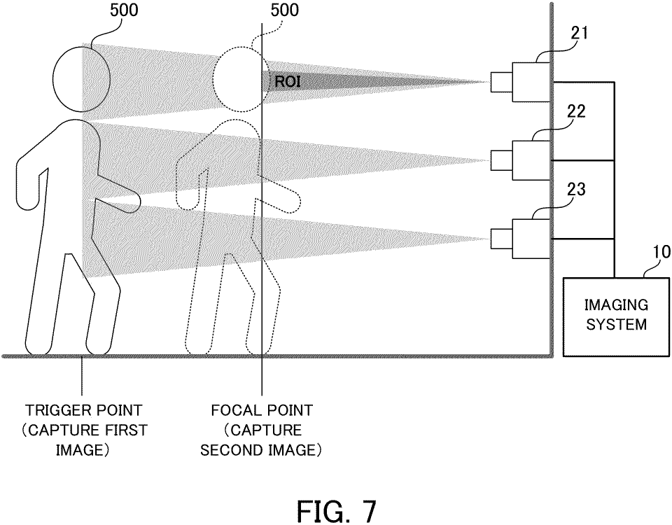

Next, with reference to FIG. 7, a technical effect obtained by the imaging system 10 according to the second example embodiment will be described. FIG. 7 is a conceptual diagram illustrating the imaging timing and imaging range of the first image and second image according to the second example embodiment. In FIG. 7, the same components as those illustrated in FIG. 4. Carry the same reference numerals.

As illustrated in FIG. 7, in the imaging system 10 according to the second example embodiment, the first image is captured by the plurality of iris cameras 20, from which the eye position is detected and the ROI is set. Here in particular, if the first image is captured only once, depending on the circumstances, the eyes may not be included in the imaging range. If, however, a plurality of first images are captured, a wider range can be imaged, thereby increasing the possibility of imaging the eye position. Therefore, it is possible to set an appropriate ROI from the eye position and it is possible to more properly capture the second image (i.e., the high-definition iris image).

The plurality of first images may not be captured by using the plurality of iris cameras 20, and the plurality of first images may be captured by a single iris camera 20. Specifically, for example, the first image may be captured from a plurality of angles by properly moving the position of one camera. Even in this case, it is possible to obtain the technical effect described above by synthesizing the plurality of first images to generate a wide-angle image.

### Third Example Embodiment

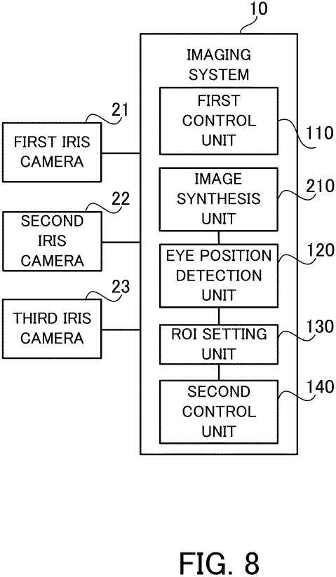

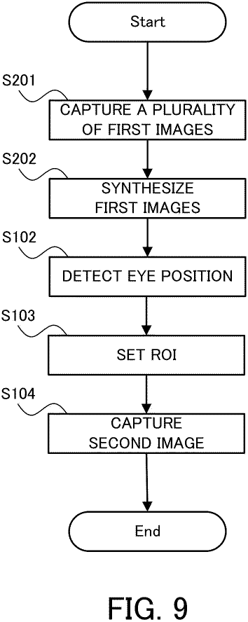

The imaging system 10 according to a third example embodiment will be described with reference to FIG. 8 and FIG. 9. The third example embodiment is partially different from the first and second example embodiments described above only in configuration and operation, and is substantially the same in the other parts. Therefore, the parts that differ from the first and second example embodiments will be described in detail below, and the other overlapping parts will not be described as appropriate.

### Hardware Configuration

A hardware configuration of the imaging system 10 according to the third example embodiment may be the same as the hardware configuration of the first example embodiment described in FIG. 1. Therefore, a description of the hardware configuration of the imaging system 10 according to the third example embodiment will be omitted.

### Functional Configuration

Next, with reference to FIG. 8, a functional configuration of the imaging system 10 according to the third example embodiment will be described. FIG. 8 is a block diagram illustrating the functional configuration of the imaging system according to the third example embodiment. In FIG. 8, the same components as illustrated in FIG. 2 and FIG. 5 carry the same reference numerals.

As illustrated in FIG. 8, the imaging system 10 according to the third example embodiment includes, as processing blocks for realizing the function, the first control unit 110, the eye position detection unit 120, the ROI setting unit 130, the second control unit 140, and an image synthesis unit 210. That is, the imaging system 10 according to the third example embodiment further includes the image synthesis unit 210 in addition to the configuration of the second example embodiment (see FIG. 5).

The image synthesis unit 210 is configured to synthesize the respective first images captured by the first iris camera 21, the second iris camera 22, and the third iris camera 23. The first iris camera 21, the second iris camera 22, and the third iris camera 23 are arranged such that their imaging ranges do not greatly overlap each other. Therefore, when the respective first images captured by the iris cameras 20 are synthesized, a single wide-angle image can be generated. The wide-angle image generated by the image synthesis unit 210 is configured to be outputted to the eye position detection unit 110. The image synthesis unit 210 may be realized or implemented, for example, in the processor 11 described above (see FIG. 1).

### Flow of Operation

Next, with reference to FIG. 9, a flow of operation of the imaging system 10 according to the third example embodiment will be described. FIG. 9 is a flowchart illustrating the flow of the operation of the imaging system according to the third example embodiment. In FIG. 9, the same steps as those illustrated in FIG. 3 and FIG. 6 carry the same reference numerals.

As illustrated in FIG. 9, in operation of the imaging system 10 according to the third example embodiment, first, the first control unit 110 controls each of the first iris camera 21, the second iris camera 22, and the third iris camera 23 to capture the first image of the subject (the step S201).

Then, the image synthesis unit 210 synthesizes the plurality of first images captured by the first iris camera 21, the second iris camera 22, and the third iris camera 23 (step S202). Subsequently, the eye position detection unit 120 detects the eye position of the subject from the wide-angle image obtained by synthesizing the plurality of first images (the step S102). Then, the ROI setting unit 130 sets the ROI on the basis of the detected eye position (the step S103).

Then, the second control unit 140 controls the iris cameras 20 to capture the second image at the set ROI (the step S104).

### Technical Effect

Next, a technical effect obtained by the imaging system 10 according to the third example embodiment will be described.

As described in FIG. 8 and FIG. 9, in the imaging system 10 according to the third example embodiment, the images captured by the plurality of iris cameras 20 are synthesized to generate a single wide-angle image. Here in particular, since the iris camera 20 is required to image the iris of the subject in a high definition, the angle of view is often set relatively narrow. According to the imaging system 10 in the third example embodiment, however, the wide-angle image is generated from the first images captured by the plurality of iris cameras 20. Therefore, even when each iris camera has a narrow angle of view, it is possible to obtain a wide-angle image suitable to detect the eye position.

### Fourth Example Embodiment

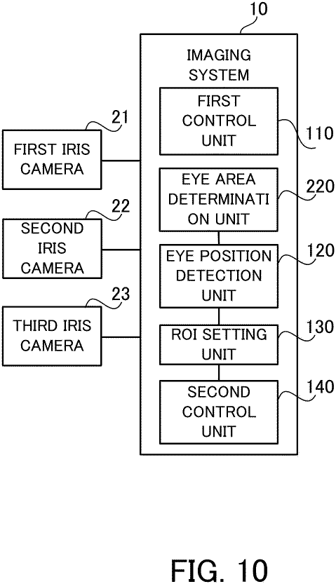

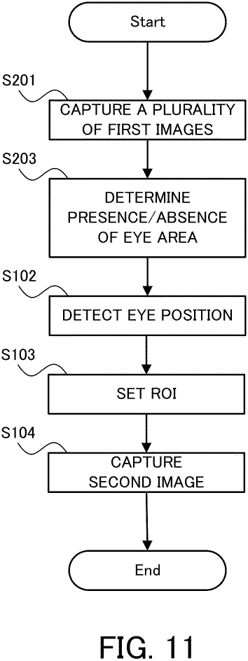

The imaging system 10 according to a fourth example embodiment will be described with reference to FIG. 10 and FIG. 11. The fourth example embodiment is partially different from the first to third example embodiments described above only in configuration and operation, and is substantially the same in the other parts. Therefore, the parts that differ from the first to third example embodiments will be described in detail below, and the other overlapping parts will not be described as appropriate.

### Hardware Configuration

A hardware configuration of the imaging system 10 according to the fourth example embodiment may be the same as the hardware configuration of the first example embodiment described in FIG. 1. Therefore, a description of the hardware configuration of the imaging system 10 according to the fourth example embodiment will be omitted.

### Functional Configuration

Next, with reference to FIG. 10, a functional configuration of the imaging system 10 according to the fourth example embodiment will be described. FIG. 10 is a block diagram illustrating the functional configuration of the imaging system according to the fourth example embodiment. In FIG. 10, the same components as those illustrated in FIG. 2, FIG. 5 and FIG. 8 carry the same reference numerals.

As illustrated in FIG. 10, the imaging system 10 according to the fourth example embodiment includes, as processing blocks for realizing the function, the first control unit 110, the eye position detection unit 120, the ROI setting unit 130, the second control unit 140, and an eye area determination unit 220. That is, the imaging system 10 according to the fourth example embodiment further includes the eye area determination unit 220 in addition to the configuration of the second example embodiment (see FIG. 5).

The eye area determination unit 220 is configured to determine whether or not an eye area is included in the first image captured by each of the first iris camera 21, the second iris camera 22, and the third iris camera 23. In other words, the eye area determination unit 220 is configured to determine which image of the plurality of first images captured by the second iris camera 22 and the third iris camera 23 includes the eye area. A determination result of the eye area determination unit 220 (i.e., information about the first image including the eye area) is configured to be outputted to the eye position detection unit 110. Incidentally, the eye area determination unit 220 may be realized or implemented, for example, in the processor 11 described above (see FIG. 1).

### Flow of Operation

Next, with reference to FIG. 11, a flow of operation of the imaging system 10 according to the fourth example embodiment will be described. FIG. 11 is a flowchart illustrating the flow of the operation of the imaging system according to the fourth example embodiment. In FIG. 11, the same steps as those illustrated in FIG. 3, FIG. 6, and FIG. 9 carry the same reference numerals.

As illustrated in FIG. 11, in operation of the imaging system 10 according to the fourth example embodiment, first, the first control unit 110 controls each of the first iris camera 21, the second iris camera 22, and the third iris camera 23 to capture the first image of the subject (the step S201).

Then, the eye area determination unit 220 determines whether or not there is an eye area, for the plurality of first images captured by the first iris camera 21, the second iris camera 22, and the third iris camera 23 (step S203). Subsequently, the eye position detection unit 120 detects the eye position of the subject from the first image for which the eye area is included (the step S102). Then, the ROI setting unit 130 sets the ROI on the basis of the detected eye position (the step S103).

Then, the second control unit 140 controls the iris camera 20 to capture the second image at the set ROI (the step S104).

### Technical Effect

Next, a technical effect obtained by the imaging system 10 according to the fourth example embodiment will be described.

As described in FIG. 10 and FIG. 11, in the imaging system 10 according to the fourth example embodiment, it is determined whether or not the eye area is included in the first image captured by each of the plurality of iris cameras 20, and the eye position is detected from the first image including the eye area. Therefore, it is possible to detect the eye position more efficiently, in comparison with when the eye position is detected from all the first images.

### Fifth Example Embodiment

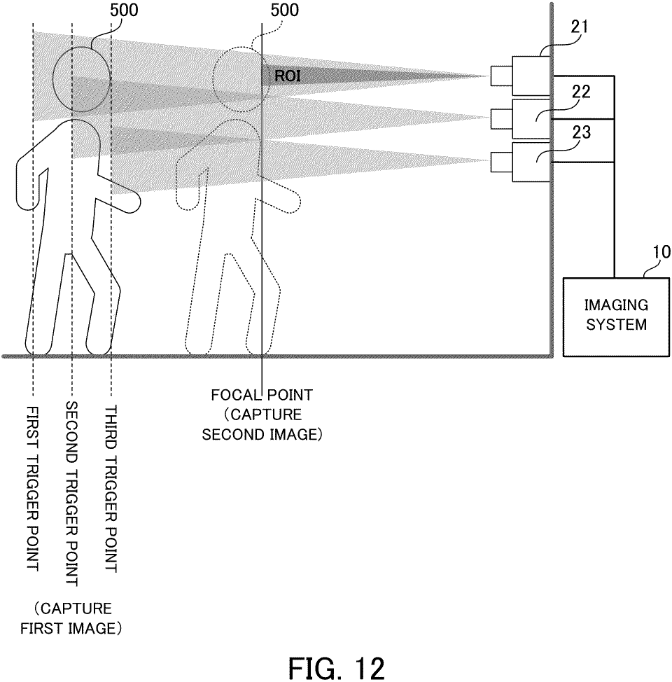

The imaging system 10 according to a fifth example embodiment will be described with reference to FIG. 12. The fifth example embodiment is intended to specifically describe another method when the first image is captured. A hardware configuration, a functional configuration, a flow of operation of the system may be the same as those in the first to fourth example embodiments described above. Therefore, the parts that differ from the first to fourth example embodiments will be described in detail below, and the other overlapping parts will not be described as appropriate.

### Multiple Imaging of First Image

First, with reference to FIG. 12, the imaging timing of the first image by the imaging system 10 according to the fifth example embodiment will be described in detail. FIG. 12 is a conceptual diagram illustrating the imaging timing and imaging range of the first image and the second image according to the fifth example embodiment. In FIG. 12, the same components as those illustrated in FIG. 4 and FIG. 7 carry the same reference numerals.

As illustrated in FIG. 12, in the imaging system according to the fifth example embodiment, the first image is captured by each of the first iris camera 21, the second iris camera 22, and the third iris camera 23 at different timing. Specifically, the first iris camera 21 captures the first image at a time when a subject 500 arrives at a first trigger point. The second iris camera 22 captures the first image at a time when the subject 500 arrives at a second trigger point. The third iris camera 23 captures the first image at a time when the subject 500 arrives at a third trigger point. Thus, if a plurality of trigger points are staggered, a plurality of first images are captured at different timing.

The eye position of the subject 500 may be detected from each of the plurality of first images captured as described above. For example, all of the plurality of first images may be used to detect the eye position, or the first image including the eye area may be determined from among the plurality of first images and only the first image including the eye area may be used to the detect the eye position.

It is preferable to set the plurality of iris cameras 20 such that an overlapping part of their imaging ranges is sufficiently large. In this way, even for the subjects 500 different in standing height, at least one iris camera 20 is allowed to capture the faces of the subjects 500 without interruption.

### Technical Effect

Next, a technical effect obtained by the imaging system 10 according to the fifth example embodiment will be described.

As described in FIG. 12, in the imaging system 10 according to the fifth example embodiment, a plurality of first images are captured at different timing. Even in this case, it is possible to detect the eye position of the subject 500, as in a case where the plurality of first images are captured at the same time.

### Sixth Example Embodiment

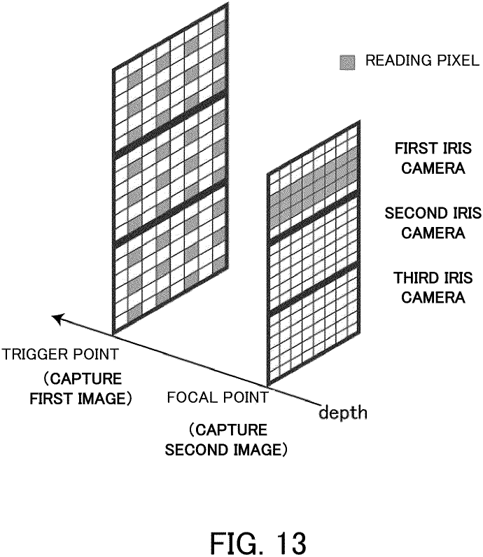

The imaging system 10 according to a sixth example embodiment will be described with reference to FIG. 13. The sixth example embodiment is intended to specifically describe a method of reducing resolution when the first image is captured. A hardware configuration, a functional configuration, a flow of operation of the system may be the same as those in the first to fifth example embodiments described above. Therefore, the parts that differ from the first to fifth example embodiments will be described in detail below, and the other overlapping parts will not be described as appropriate.

### Lower Resolution by Reducing Pixels

First, with reference to FIG. 13, a reduction in the resolution of the first image in the imaging system 10 according to the sixth example embodiment will be described. FIG. 13 is a conceptual diagram illustrating an operation when pixels are thinned out and the first image of low resolution is captured.

As illustrated in FIG. 13, in the imaging system 10 according to the sixth example embodiment, the resolution of the first image is reduced by thinning out the pixels of the iris camera 20. Specifically, the first control unit 110 reduces the number of pixels to be read in the imaging of the first image, for example, by using a method of binning or the like. This reduces the pixel density of the first image. On the other hand, the second control unit 140 may not thin out the pixels in the imaging of the second image (wherein an imaging area is limited to the ROI). In this way, the pixel density of the second image becomes greater than that of the first image.

A pixel reduction amount by thinning may be changed depending on a location of the imaging area. In other words, the pixel reduction amount by thinning may not be uniform throughout the imaging area. For example, the pixel reduction amount by thinning may be reduced for an area that likely includes the eye area, and the pixel reduction amount by thinning may be increased for an area that less likely includes the eye area.

### Technical Effect

Next, a technical effect obtained by the imaging system 10 according to the sixth example embodiment will be described.

As described in FIG. 13, in the imaging system 10 according to the sixth example embodiment, the reduction in the resolution of the first image is realized by thin out the pixels. Consequently, it is possible to prevent an increased data volume of the first image, thereby to shorten a period required for the communication and processing of the first image

### Seventh Example Embodiment

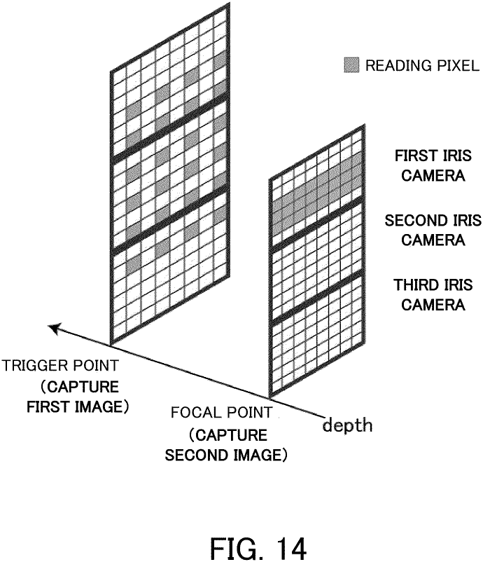

The imaging system 10 according to a seventh example embodiment will be described with reference to FIG. 14. The seventh example embodiment is intended to specifically describe a method of reducing the data volume when the first image is captured. A hardware configuration, a functional configuration, a flow of operation of the system may be the same as those in the first to sixth example embodiments described above. Therefore, the parts that differ from the first to fifth example embodiments will be described in detail below, and the other overlapping parts will not be described as appropriate.

### Limiting of Imaging Area

First, with reference to FIG. 14, a reduction in the data volume of the first image in the imaging system 10 according to the seventh example embodiment will be described. FIG. 14 is a conceptual diagram illustrating an operation when the imaging area is limited to be small and the first image is captured.

As illustrated in FIG. 14, in the imaging system 10 according to the seventh example embodiment, the reduction in the data volume of the first image is realized by limiting (i.e., narrowing) the imaging area of the iris camera 20 to be small. Specifically, in the imaging of the first image, the first control unit 110 does not read the pixels of at least one of an upper end part and a lower end part of the imaging area (e.g., an area that is estimated to less likely includes the eyes of the subject). This reduces the data volume of the first image. As described in the sixth example embodiment, since the first image is captured while the pixels are thinned out, the pixel density is also reduced. Therefore, the data volume of the first image is significantly reduced.

Furthermore, in addition to or in place of the upper end part and the lower end part described above, the pixels of at least one of a right end part and a left end part of the imaging area may not be read. For example, when the subject passes through the center of a passage (such as when an arrow is painted on a floor and the subject is guided to the center of the passage), the right end part and the left end part of the imaging area less likely includes the eyes of the subject. Therefore, by not reading the pixels of at least one of the right end part and the left end part of the imaging area, it is possible to r efficiently educe the data volume of the first image.

### Technical Effect

Next, a technical effect obtained by the imaging system 10 according to the seventh example embodiment will be described.

As described in FIG. 14, in the imaging system 10 according to the seventh example embodiment, a further reduction in the data volume of the first image is realized by narrowing the imaging area of the iris camera 20. Therefore, it is possible to prevent an increased data volume of the first image, thereby to shorten a period required for the communication and processing of the first image.

### Supplementary Notes

The example embodiments described above may be further described as, but not limited to, the following Supplementary Notes.

### Supplementary Note 1

An imaging system described in Supplementary Note 1 is an imaging system including: a first control unit that controls an imaging unit to capture a first image of a subject at a first pixel density; a detection unit that detects an eye position of the subject from the first image; a setting unit that sets a peripheral area around eyes of the subject on the basis of the eye position; and a second control unit that controls the imaging unit to capture a second image of the peripheral area at a second pixel density that is higher than the first pixel density.

### Supplementary Note 2

An imaging system described in Supplementary Note 2 is the imaging system described in Supplementary Note 1, wherein the first control unit performs a process to thin out pixels of the imaging unit, so that the first pixel density becomes lower than the second pixel density.

### Supplementary Note 3

An imaging system described in Supplementary Note 3 is the imaging system described in Supplementary Note 1 or 2, wherein the first control unit reduces a data volume of the first image by limiting an imaging area of the imaging unit to be small.

### Supplementary Note 4

An imaging system described in Supplementary Note 4 is the imaging system described in any one of Supplementary Notes 1 to 3, wherein the imaging unit includes a plurality of cameras, and the first control unit controls the imaging unit to capture the first image with each of the plurality of cameras.

### Supplementary Note 5

An imaging system described in Supplementary Note 5 is the imaging system described in any one of Supplementary Notes 1 to 4, wherein the detection unit detects the eye position of the subject from a composite image obtained by synthesizing a plurality of first images.

### Supplementary Note 6

An imaging system described in Supplementary Note 6 is the imaging system described in any one of Supplementary Notes 1 to 5, wherein the first control unit controls the imaging unit to capture the first image when the subject arrives at a predetermined trigger point.

### Supplementary Note 7

An imaging system described in Supplementary Note 7 is the imaging system described in any one of Supplementary Notes 1 to 6, wherein the second imaging unit controls the imaging unit to capture the second image when the subject arrives at a focal point set in advance.

### Supplementary Note 8

An imaging system described in Supplementary Note 8 is the imaging system described in any one of Supplementary Notes 1 to 7, further including an authentication unit that performs iris authentication of the subject by using the second image.

### Supplementary Note 9

An imaging method described in Supplementary Note 9 is an imaging method including: controlling an imaging unit to capture a first image of a subject at a first pixel density; detecting an eye position of the subject from the first image; setting a peripheral area around eyes of the subject on the basis of the eye position; and controlling the imaging unit to capture a second image of the peripheral area at a second pixel density that is higher than the first pixel density.

### Supplementary Note 10

A computer program described in Supplementary Note 10 is a computer program that operates a computer: to control an imaging unit to capture a first image of a subject at a first pixel density; to detect an eye position of the subject from the first image; to set a peripheral area around eyes of the subject on the basis of the eye position; and to control the imaging unit to capture a second image of the peripheral area at a second pixel density that is higher than the first pixel density.

This disclosure is not limited to the examples described above and is allowed to be changed, if desired, without departing from the essence or spirit of the invention which can be read from the claims and the entire specification. An imaging system, an imaging method, and a computer program with such modifications are also intended to be within the technical scope of this disclosure.

Description of Reference Codes

| | |
|---|---|
| 10 | Imaging system |
| 20 | Iris camera |
| 21 | First iris camera |
| 22 | Second iris camera |
| 23 | Third iris camera |
| 110 | First control unit |
| 120 | Eye position detection unit |
| 130 | ROI setting unit |
| 140 | Second control unit |
| 210 | Image synthesis unit |
| 220 | Eye area determination unit |
| 500 | Subject |

What is claimed is:

1. An imaging system comprising:
at least one memory that is configured to store instructions; and
at least one processor that is configured to execute instructions
to control an imaging unit to capture a first image of a subject at a first pixel density;
to detect an eye position of the subject from the first image;
to set a peripheral area around eyes of the subject on the basis of the eye position; and
to control the imaging unit to capture a second image of the peripheral area at a second pixel density that is higher than the first pixel density.

2. The imaging system according to claim 1, wherein the processor performs a process to thin out pixels of the imaging unit, so that the first pixel density becomes lower than the second pixel density.

3. The imaging system according to claim 1, wherein the processor reduces a data volume of the first image by limiting an imaging area of the imaging unit to be small.

4. The imaging system according to claim 1, wherein
the imaging unit includes a plurality of cameras, and
the processor controls the imaging unit to capture the first image with each of the plurality of cameras.

5. The imaging system according to claim 1, wherein the processor detects the eye position of the subject from a composite image obtained by synthesizing a plurality of first images.

6. The imaging system according to claim 1, wherein the processor controls the imaging unit to capture the first image when the subject arrives at a predetermined trigger point.

7. The imaging system according to claim 1, wherein the processor controls the imaging unit to capture the second image when the subject arrives at a focal point set in advance.

8. The imaging system according to claim 1, further comprising a processor that is configured to execute instructions to perform iris authentication of the subject by using the second image.

9. An imaging method comprising:
controlling an imaging unit to capture a first image of a subject at a first pixel density;
detecting an eye position of the subject from the first image;
setting a peripheral area around eyes of the subject on the basis of the eye position; and
controlling the imaging unit to capture a second image of the peripheral area at a second pixel density that is higher than the first pixel density.

10. A non-transitory recording medium on which a computer program that allows a computer to execute an imaging method is recorded, the imaging method comprising:
controlling an imaging unit to capture a first image of a subject at a first pixel density;
detecting an eye position of the subject from the first image;
setting a peripheral area around eyes of the subject on the basis of the eye position; and
controlling the imaging unit to capture a second image of the peripheral area at a second pixel density that is higher than the first pixel density.
